(19) United States
(12) Patent Application Publication
(10) Pub. No.: US 2002/0077815 A1
(43) Pub. Date: Jun. 20, 2002

(54) Information search method based on dialog and dialog machine

(75) Inventors: Zhifeng Zhang, Beijing (CN); Liping Yang, Beijing (CN)

Correspondence Address: IBM CORPORATION, INTELLECTUAL PROPERTY LAW DEPT., P.O. BOX 218, YORKTOWN HEIGHTS, NY, 10598, US

(73) Assignee: International Business Machines Corporation, Armonk, NY

(21) Appl. No.: 09/894,041

(22) Filed: Jun. 28, 2001

(30) Foreign Application Priority Data
Jul. 10, 2000 (CN) 00120458.0

(51) Int. Cl. G10L 15/04; G10L 15/00

(52) U.S. Cl. 704/251

(57) ABSTRACT

This invention discloses a method for searching information by means of dialog with user in all kinds of search engines. The user can do search by using natural language and the search engine can guide him to what he wants through dialog. The method comprises the steps of: receiving user's natural sentence for inquiring; searching nodes to find the node matching with the user's natural sentence; responding to user's natural sentence with the dialogs of said node, wherein the dialogs illustrate implicitly or explicitly the classification principle of the documents of said node; and, repeating the above steps, narrowing the search range gradually to attain the target node or determine there is not said node by means of dialogs with the user.

### FIELD OF THE INVENTION

This invention discloses a dialog machine capable of being applied in various types of search engines, and a method for performing information search by dialog, wherein a user can use a natural sentence to perform information search and be guided to perform a search by the search engines in a manner of communication with the user.

### BACKGROUND OF THE INVENTION

We propose a method of dialog for all kinds of category classifications of documents which possess tree structure and each node of this tree can be represented by one or several keywords. Through this method of dialog, the search engine can communicate with the user through natural sentences to help the user to find the results the user wants or guide the user to the results when the user is not very clear about what he/she wants. This method can be carried out for the kinds of search engines which exhibit category classifications of documents to the user or the kinds of search engines which have category classifications of documents but do not exhibit the category classifications to the user. But for the kinds of search engines which have category classifications of documents but do not exhibit category classifications to the user, this solution method will make the search engines more “human”.

This invention describes a dialog machine capable of being applied in web search engines, and a method for performing search by dialog. For all the search engines which possess large amounts of information, it is seen that all kinds of category classifications of documents according to different principles can be realized. For example, Yahoo, Altavista, etc. have web directories which put the documents of the same interest in the same directory, a web directory. The classification of documents in Yahoo, Altavista etc. represents a kind of category classification of documents. The common property of these classifications is that a category tree is constructed. Each node of the category tree represents a directory which contains all kinds of documents, and each node can be represented by one or several keywords in the mind of people. Because all kinds of category classifications of documents possess tree structure and at each node of this tree can be represented by one or several keywords, we propose a method of dialog. Through this method of dialog, the search engine can communicate with the user through natural sentences to help the user to find the results the user wants or guide the user to the results when the user is not very clear about what he/she wants. This method can be carried out for the kinds of search engines which exhibit category classifications of documents to the user or the kinds of search engines which have category classifications of documents but do not exhibit the category classifications to the user. But for the kinds of search engines which have category classifications of documents but do not exhibit category classifications to the user, this solution method will make the search engines more “human”.

### SUMMARY OF THE INVENTION

According to an aspect of the present invention, there is provided a method for performing information search in web search engines by dialog, comprising the steps of:

receiving a user's natural sentence for inquiring; searching nodes to find the node matching with the user's natural sentence;

responding to the user's natural sentence with the dialogs of said node, wherein the dialogs illustrate implicitly or explicitly the classification principle of the documents of said node; and

repeating the above steps, narrowing the search range gradually to attain the target node or determine there is not said node by means of dialogs with the user.

According to another aspect of the present invention, there is provided a dialog machine for use in web search engines, the dialog machine comprising:

dialog inputting means, for receiving a user's natural sentence for inquiring;

node matching means, for searching nodes to find a node matching with the user's natural sentence;

dialog responding means, for responding to the user's natural sentence with the dialogs of said node, wherein the dialogs illustrate implicitly or explicitly the classification principle of the documents of said node.

The novelty of this invention and the key points are that we propose to assign a dialog set for each node in the category tree and this dialog set is constructed manually. And each natural sentence of this dialog set is a natural sentence which implicitly or explicitly describes the classification principles related to this node. Also, each node possesses all the keywords that this node's parent node possesses. And each natural sentence of the dialog set prompts the user to respond such that it can lead the user to a more specified sub-node which is composed of more specified documents.

### BRIEF DESCRIPTION OF THE DRAWINGS

The novelty and other features of this invention become more apparent, through the following explanation in conjunction with the accompanying diagrams, in which:

FIG. 1 is a schematic view of a category tree;

FIG. 2 is a flow diagram of a method for performing information search in web search engines by dialog according to an embodiment of the invention;

FIG. 3 is a flow diagram of a method for performing information search in web search engines by dialog according to another embodiment of the invention;

FIG. 4 is a flow diagram of an inventive method for performing information search in web search engines by dialog when the document classification has the tree structure shown in FIG. 1 according to another embodiment of the invention;

FIG. 5 is a block diagram of a dialog machine according to an embodiment of the invention; and

FIG. 6 is a block diagram of a dialog machine according to another embodiment of the invention.

FIG. 7 shows varous characters used to demonstrate the operation of the invention.

### DETAILED DESCRIPTION OF PREFERRED EMBODIMENTS

The invention is described in conjunction with particular embodiments, for example, if the user asks: “I want to know about Chinese history.”

Then we have the keywords: “Chinese, history”.

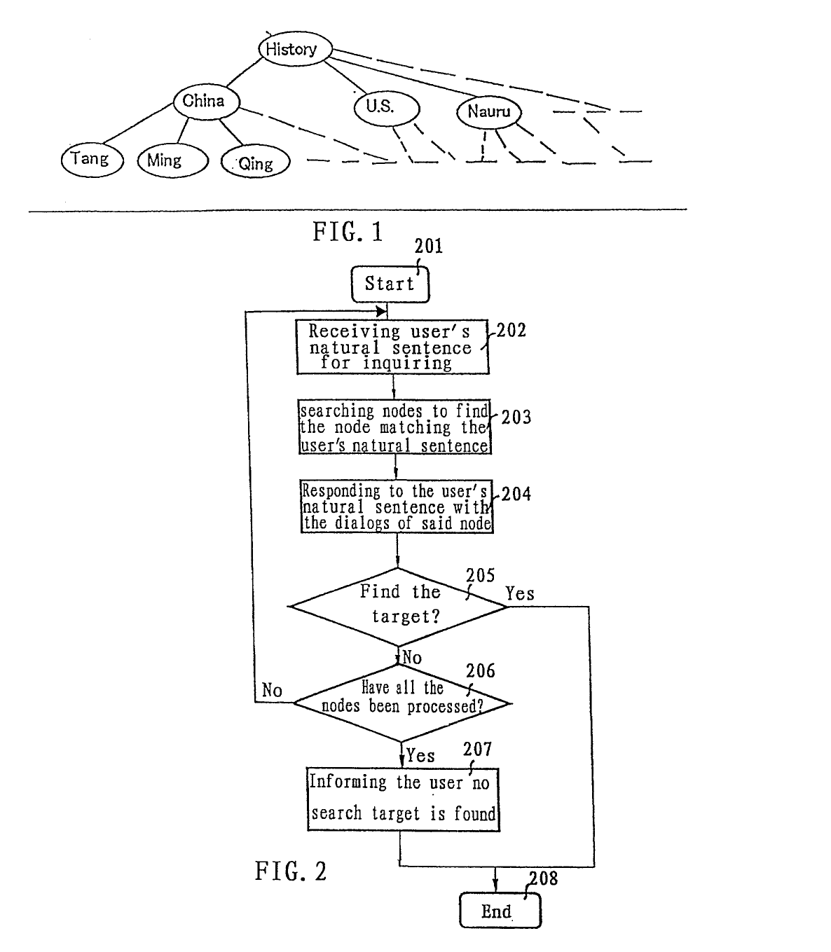

A part of the category classification may be shown as FIG. 1.

Then we assign the “China” node to the natural sentence “I want to know about Chinese history.” because this sentence has two keywords “Chinese” and “history”. The node “China” may have been assigned for the keywords “China”, “Chinese” etc. Because we assume that it also contains all the keywords of the node “China”'s parent node. So the node “China” contains the two keywords “Chinese” and “history” of the natural sentence “I want to know about Chinese history.” Then we assign the “China” node to the natural sentence “I want to know about Chinese history.” Then we get a natural sentence from the dialog set of the node “China” to respond to the user. This natural sentence may be “China has five thousand years'history. Many dynasties have passed in the five thousands years. Which dynasty's history are you interested?”. Now we come to our invention on the dialog set of a category node and a method to construct the dialog set of the category node. A dialog set is the set of all natural sentences related to a node. The reason that we assign a set of natural sentences for the node instead of only one natural sentence for the node is that we can randomly select one natural sentence from the dialog set and by this way we make our computer more “human” in the sense that for the same natural sentence raised repeatedly by a user, the user may find he does not get the same response and the same response may make the user feel that the computer is dull. We say that the natural sentence in the dialog set of a category node should reflect implicitly or explicitly the classification principle of the category node. For the above example, we can assign a natural sentence to the dialog set of the node “China” and this natural sentence can be “China has five thousand years'history. Many dynasties have passed in the five thousands years. Which dynasty's history are you interested?” which has been shown above. Because this natural sentence suggests to the user that the classification principle of the node “China” is according to the dynasties of Chinese history. Then the user may respond by “I want to know about Tang dynasty”. Then we come to the category node “Tang” and the node “Tang” may have another kind of classification principle and we assigned natural sentences to the dialog set of the node “Tang” according to the classification principle of the node “Tang”. We get the natural sentence from the node “Tang” as a response to the user. This natural sentence could be “Fine! Tang dynasty is a very prosperous dynasty in the history of China. We have the information of Buddhism, famous poets and all the emperors etc. in the Tang dynasty. What kind of information are you interested in?” Through this way, search engines will direct the user to deeper dialog sets of category sub-nodes until finally get the result the user wants. Of course, the user may not answer by following the way as we desired. As to this case, our solution is to extract keywords of the user's responding natural sentence and then we first traverse the route from the root node to the current node to find the first node the keywords of which contains the keywords of the natural sentence. If the node is not found we traverse the sub-tree from the current node (using a ‘breadth-first’ algorithm) to find the first sub-node which contains all the keywords which the user uses in the natural sentence. If we cannot find a sub-node which contains the set of keywords of the sentence, we traverse the tree from the root node (using a ‘breadth-first’ algorithm) to find the first node which contains the set of keywords of this sentence. Then we select a natural sentence from the dialog set of the node. If the node is not found we give the user a response such as:

“Sorry, no information is found!” etc. We will always suppose the root node of our category tree contains no keyword.

Therefore, for search engines without the function of dialog, an object of the invention is to propose a solution which can realize a dialog function. We should notice that the above solution proposal can always respond to all the queries raised by the user.

Description of terms used in this document:

Category Tree: A category tree related to document classification in our sense is a tree in which the set of all the documents related to each sub-node of a node belong to the set of the documents of the node. And each node of the category tree is also assigned to some keywords and the set of keywords of each node also contains the set of keywords of its direct parent node. And some principles are used to classify the documents.

Category Node: A category node is a node of a category tree. In our sense, a category node is also assigned for a set of keywords. And it is related to a set of documents.

Dialog Set of Category Node: A dialog set of a category node is the set of all the natural sentences which a category node possesses. From the dialog set we can select a natural sentence to respond to the user while a user talks to the computer through natural sentences.

The Structure of Category Tree:

Suppose W is a ground set which we can consider as the set of all words in the implementation.

Suppose S is a ground set which we can consider as the set of all sentences in the implementation.

In the following discussion, we use W, S as above.

Definition: We call a tree a category-tree, if this tree possesses the following four properties:

1. Every node of this tree possesses two sets, one is called the keyword set which belongs to W, for short K-set, and the other is called the dialog set which belongs to S, for short D-set.

2. If a node of the tree is not the root node, then the K-set of this node contains the K-set of its direct parent node.

3. The K-set of the root node is the null set.

4. A universal node which is not a node of the tree is assigned to the tree. This universal node also possesses a keyword set and a dialog set. The keyword set of this universal node is the set W.

The method of constructing the dialog set for a node of a category-tree

The root node:

This node corresponds the everyday dialogs; we collect some everyday dialogs and for each natural sentence which contains no keyword, we will select a natural sentence from this node to respond to the user.

The universal node:

This dialog set should contain some natural sentences which tell the user no answer can be found for the queries that the user asks, for example:

“Sorry! No answers can be found to answer your question.”

“In this world, things are not always going well, so we did not find the answers corresponding to your question.” etc.

Other nodes:

For each node except the root node and the universal node, each natural sentence in the dialog set of this node should always imply implicitly or explicitly the classification principle of the documents corresponding to this node, e.g. (the above example):

“I want to know about Chinese history.” corresponds to “China” node. We can explicitly assign a natural sentence such as: “We have the information of Tang dynasty, Ming dynasty and Qing dynasty. Which one of the above three dynasties do you want to know about?” Or we can implicitly assign a natural sentence such as: “China has five thousands year's history. Many dynasties have passed in the lost five thousands years. Maybe there is a special dynasty which you are interested in very much. So tell me and I will give a lot of information.”

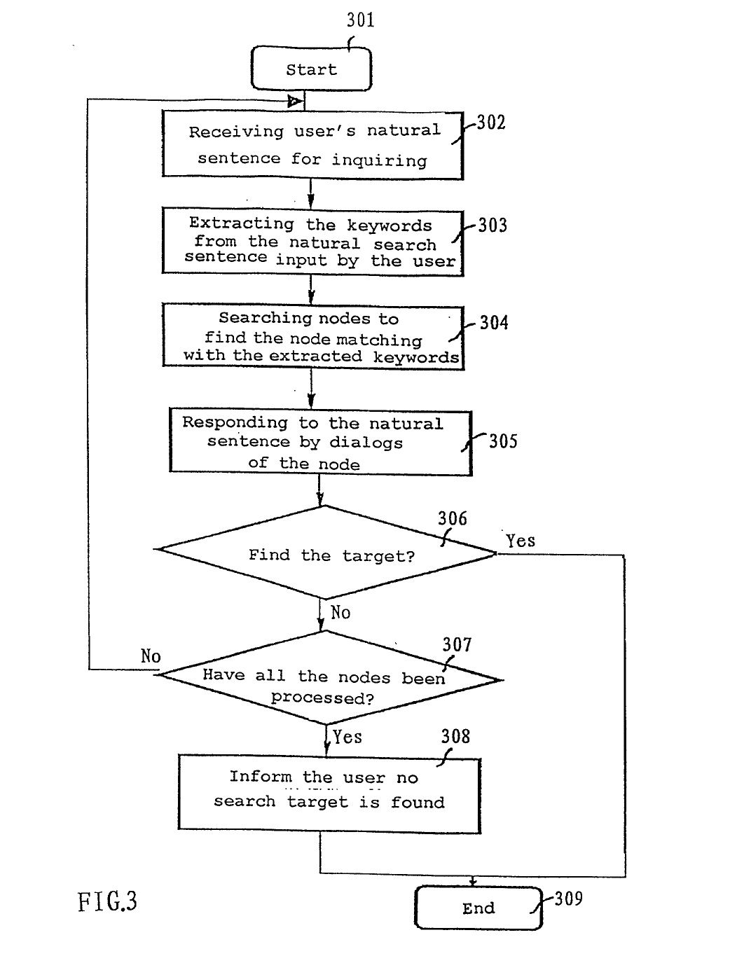

FIG. 2 is a f low chart showing a method for performing information search by dialog in web search engines according to an embodiment of the invention. As shown in FIG. 2, in step 202, user's natural sentence for inquiring is received; in step 203, the node matching with the user's natural sentence is searched; in step 204, the user's natural sentence is responded to with the dialogs of the node, wherein the dialogs illustrate the classification principle of the document of the node explicitly or implicitly; in step 205, it is determined whether the contents in the node are the information that the user wants to find, and if yes, the process ends; if not, it is determined whether all nodes have been processed, and if yes, the user is informed that the target node does not exist, if not, the search range is gradually reduced through communicating with the user, finally to reach the target node or judge that there is no such target node.

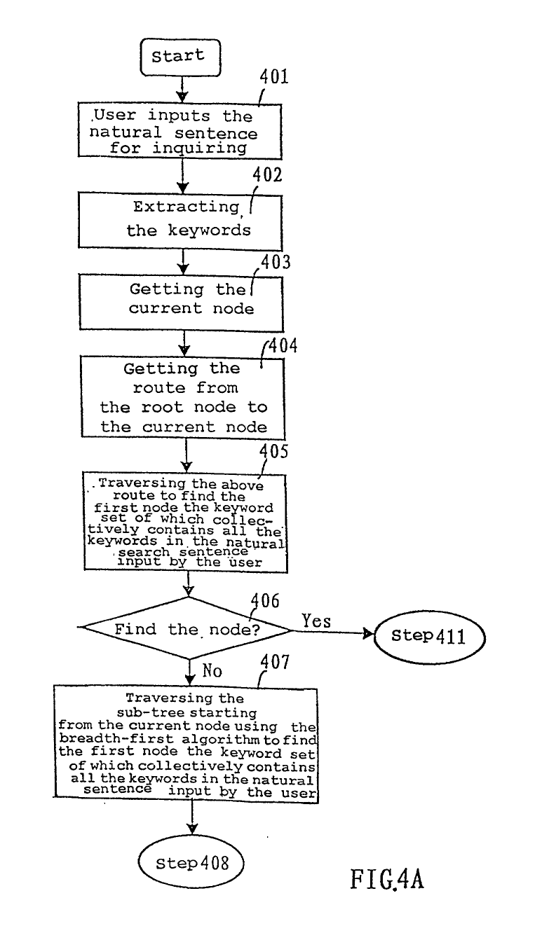

FIG. 3 is a flow chart showing a method for performing information search by dialog in web search engines according to another embodiment of the invention. The difference between this embodiment and that in FIG. 2 is, after receiving the user's natural sentence for inquiring, the keywords from the natural sentence input by the user are extracted and then the node corresponding to the extracted keywords is found.

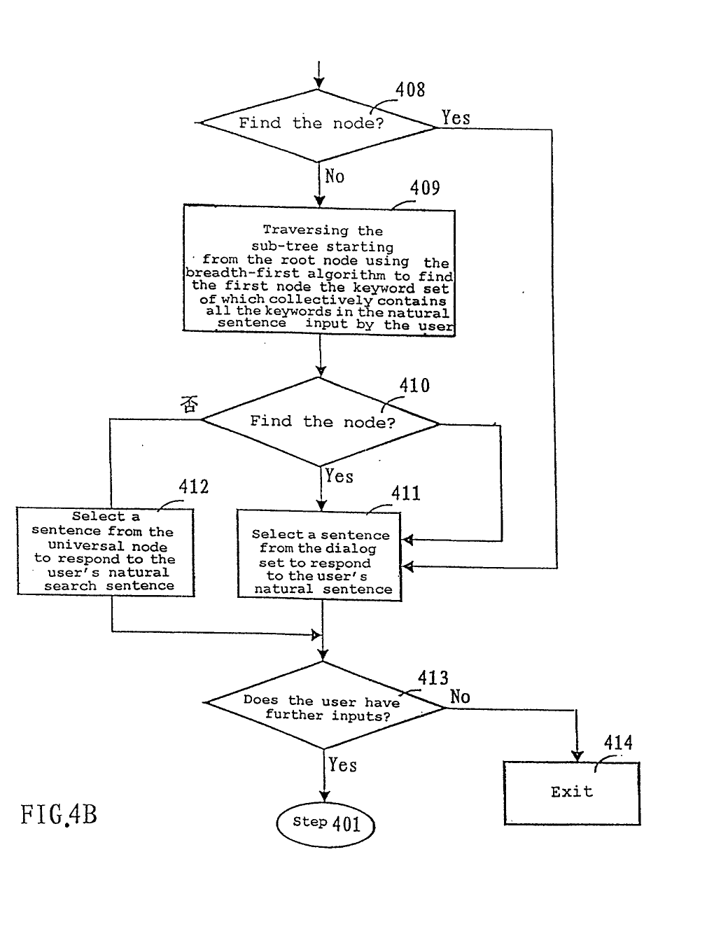

FIG. 4 shows the operating f low chart of the method of the invention f or performing information search by dialog when the document classification has a tree-like structure as shown in FIG. 1 according to an embodiment of the invention.

step 401

User's Input

In this step, the user inputs a natural sentence, for example, the user may input “I want to know about Chinese history.” or “Soccer is wonderful”.

Step 402

Extracting the Keywords

We get all the keywords related to this natural sentence. For different search engines, the calculation algorithm for keywords could be different.

One calculation of keywords is as follows:

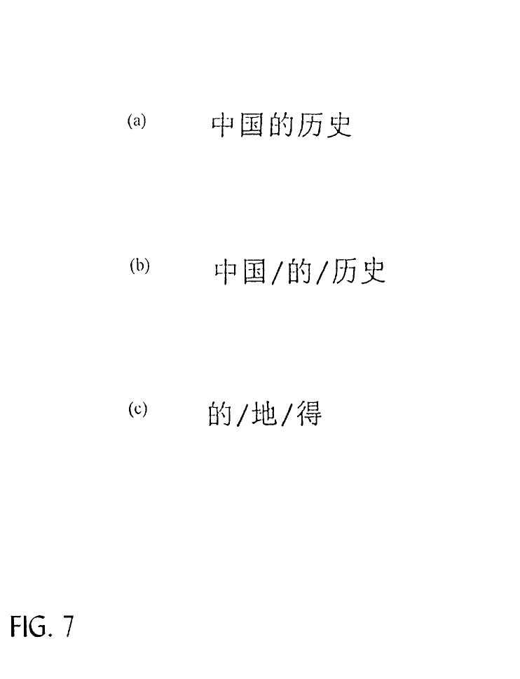

For English, all the nouns except those in the stopword dictionary are keywords, and all the words whose first letter is a capital in the dictionary are keywords. For Chinese, all the nouns except those in the stopword dictionary are keywords. We need to point out here that the characters shown in FIG. 7(a) are segmented as shown in FIG. 7(b). We mean that the characters shown in FIG. 7(c) are considered as stopwords in our segmentation algorithm.

Step 403

Getting the Current Node

In the first step the current node is the root node and in other steps, the current node is derived as described in

Step 411 and Step 412.

Step 404

Getting the route from the root node to the current node, in this step, we get the unique route of the tree from the root node to the current node.

Step 405

Traversing the route to find the first node of the keyword set which contains the set of keywords of the sentence:

In this step, we traverse the route from the root node to the current node to find the first node that contains the keyword set of the sentence.

If the node can be found, we go to Step 411, and if the node cannot be found, we go to the next step.

Step 407: Traversing the sub-tree starting from the current node using the breadth-first algorithm to find the first node the keyword set of which contains the set of keywords of the sentence, in this step, we traverse the sub-tree whose root is the current node, by using the “breadth-first algorithm” to find the first node that contains the keyword set.

If the node can be found, go to Step 411 and if the node cannot be found we go to the next step.

Step 409: Traversing the tree starting from the root node using the breadth-first algorithm to find the first node the keyword set of which contains the set of keywords of the sentence.

In this step, we traverse the whole tree starting from the root node by using the “breadth-first algorithm” to find the first node that contains the keyword set of the sentence.

If the node can be found, go to Step 411 and if the node cannot be found, we go to Step 412.

Step 411: Getting a natural sentence from the dialog set, we select a natural sentence from the dialog set of the node being found randomly by using a random function. And we define the current node as the node being found. Then we go to Step 413.

This random function is designed as follows: we get the time (measured by seconds) when the user submits a natural sentence. We divide the time (measured by seconds) by the number of sentences in the dialog set and get the remainder. This remainder plus one is the number that we use to choose the natural sentence in the dialog set. For example: if the remainder plus one is 5, we get the fifth sentence in the dialog set to respond to the user.

Step 412: Getting a natural sentence from the universal node, we get a natural sentence from the dialog set of the universal node by using the algorithm described in Step 411. And we let the current node be the root node. Then we go to the next step.

Step 413: Does the user decide to quit?

If the user decides to quit we exit our application and if not we go to step 401.

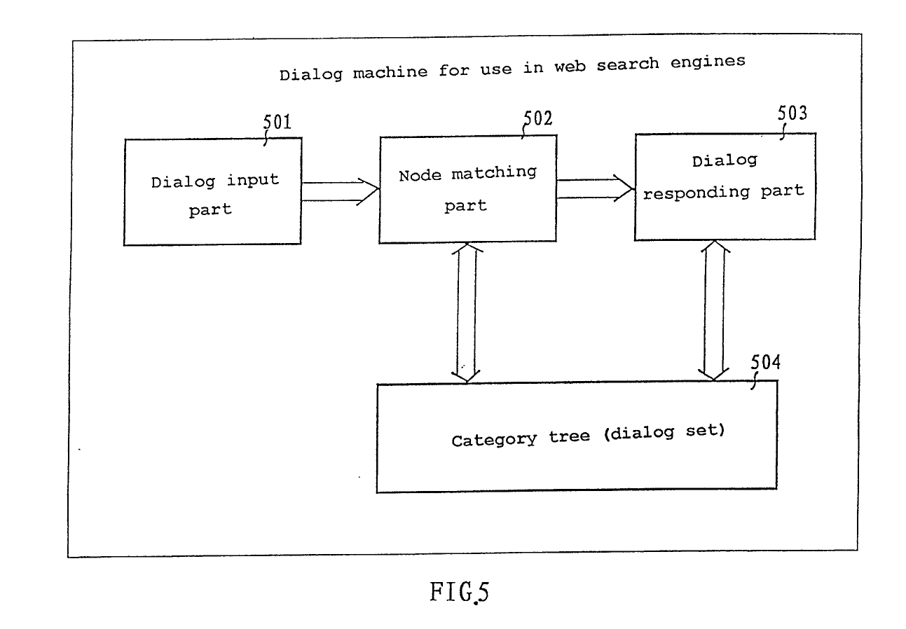

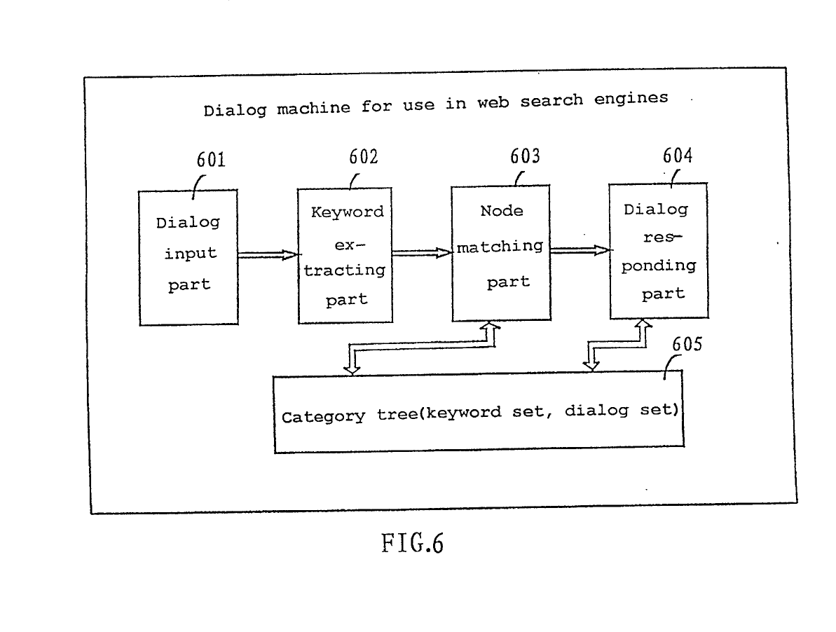

We have described the method for performing information search by dialog in web search engines in conjunction with the embodiment of the invention. Next we will describe the dialog machine used in web search engines in conjunction with FIG. 5 and 6.

As shown in FIG. 5, the dialog machine of the invention includes:

a dialog input part (501) for receiving a user's natural search sentence;

a node matching part (502) for looking for the node which matches to the user's natural sentence; and

a dialog responding part (503) for responding to said natural search sentence by dialog in the node, wherein the dialog illustrates the document classification principles of the node in an implicit or explicit manner.

FIG. 6 shows a dialog machine according to another embodiment of the invention. The dialog machine further includes a keyword extraction part 602 for extracting keywords from the natural search sentence input by the user, and a node matching part (603) for finding the node matching with the extracted keywords.

It can be seen from the above description of the particular embodiment of the invention in conjunction with the accompanying diagrams that the dialog machine used in web search engines and the method for performing information search by dialog in web search engines can make the user perform information search by natural sentences, and thus make the search engines more “human”.

Those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

While the present invention has been described above in combining with the embodiments, those skilled in the art can make a plurality of changes and modifications without departing from the spirit and the essential of the invention, and those changes and modifications intend to be included by the invention whose scope is defined by the appending claims.

1. In web search engines, a method for searching information by means of dialog with a user, comprising the steps of:
(a) receiving the user's natural sentence for inquiring;
(b) searching nodes to find a node matching with the user's natural sentence;
(c) responding to the user's natural sentence with dialogs of said node, wherein the dialogs illustrate implicitly or explicitly a classification principle of documents of said node; and
(d) repeating steps (a)-(d), narrowing the search range gradually to attain a target node or determine there is not said node by means of dialogs with the user.

2. The method according to claim 1, wherein said searching step comprises:
extracting keywords from the user's natural sentence;
searching nodes to find the node the keyword set of which contains the set of keywords of the user's natural sentence or most of the keywords of the user's natural sentence.

3. The method according to claim 2, wherein said nodes are the nodes of a category tree, said category tree possessing the following properties:
every node of the category tree possesses two sets: a keyword set and a dialog set;
if a node of the tree is not the root node, then the keyword set of this node contains the keyword set of its direct parent node;
the keyword of the root node is the null set; and a universal node.

4. A method according to claim 3, wherein said dialog set of the node possesses the following properties:
the dialog set of the root node corresponds to the everyday dialogs;
the dialog set of the universal node contains some natural sentences which tell the user no answer can be found for the queries that the user asks;
the dialog set of other nodes contains some natural sentences, wherein each natural sentence always illustrates implicitly or explicitly the classification principle of the documents corresponding to this node.

5. A method according to claim 2, wherein said searching step comprises the steps of:
obtaining the current node;
obtaining a route from the root node to the current node; traversing the route to find the first node the keyword set of which contains the set of keywords of the sentence;
if the node can not be found, traversing the subtree starting from the current node using the algorithm of breadth-first traversal to find the first node the keyword set of which contains the set of keywords of the sentence or most of the keywords of the sentence;
if the node can not be found, traversing the subtree starting from the current node using the algorithm of breadth-first traversal to find the first node the keyword set of which contains the set of keywords of the sentence or most of keywords of the sentence.

6. A dialog machine in a web search engine, comprising:
dialog inputting means, for receiving a user's natural sentence for inquiring;
node matching means, for searching nodes to find a node matching with the user's natural sentence;
dialog responding means, for responding to the user's natural sentence with dialogs of said node, wherein the dialogs illustrate implicitly or explicitly a classification principle of documents of said node.

7. A dialog machine according to claim 6, wherein said dialog machine further comprises:
keyword extracting means for extracting keywords from the user's natural sentence; and said node matching means for searching nodes to find the node the keyword set of which contains the set of keywords of the user's natural sentence or most of the keywords of the user's natural sentence.

8. A dialog machine according to claim 7, wherein said nodes are the nodes of a category tree, said category tree possessing the following properties:
every node of the tree possesses two sets: a keyword set and a dialog set;
if a node of the tree is not the root node, then the keyword set of this node contains the keyword set of its direct parent node;
the keyword of the root node is the null set; and a universal node.

9. A dialog machine according to claim 8, wherein said dialog set of the node possesses the following properties: the dialog set of the root node corresponds to the everyday dialogs;
the dialog set of the universal node contains some natural sentences which tell the user no answer can be found for the queries that the user asks;
the dialog set of other nodes contains some natural sentences, wherein each natural sentence implies implicitly or explicitly the classification principle of the documents corresponding to this node.

10. A dialog machine based on category tree according to claim 6, wherein said node matching means includes:
means for obtaining the current node;
means for obtaining a route from the root node to the current node;
traversing the route to find the first node the keyword set of which contains the set of keywords of the sentence;
if the node can not be found, traversing the subtree starting from the current node using the algorithm of breadth-first traversal to find the first node the keyword set of which contains the set of keywords of the sentence or most of the keywords of the sentence;
if the node can not be found, traversing the subtree starting from the current node using the algorithm of breadth-first traversal to find the first node the keyword set of which contains the set of keywords of the sentence or most of keywords of the sentence.

11. A computer program product in a computer readable medium for use for use searching information by means of dialog with a user, the computer program product comprising:
first instructions for receiving the user's natural sentence for inquiring;
second instructions for searching nodes to find a node matching with the user's natural sentence;
third instructions for responding to the user's natural sentence with dialogs of said node, wherein the dialogs illustrate implicitly or explicitly the classification principle of the documents of said node; and
fourth instructions for repeating the first, second and third instructions, narrowing the search range gradually to attain a target node or determine there is not said node by means of dialogs with the user.
